(19) United States
(12) Patent Application Publication
(10) Pub. No.: US 2021/0109377 A1
(43) Pub. Date: Apr. 15, 2021

(54) ORTHOKERATOLOGY LENS WITH ASPHERIC STRUCTURE IN REVERSE CURVE

(71) Applicant: BRIGHTEN OPTIX CORP., Taipei (TW)

(72) Inventors: I-Tsung WU, Taipei (TW); Wen-Pin LIN, Taipei (TW)

(21) Appl. No.: 17/125,473

(22) Filed: Dec. 17, 2020

Related U.S. Application Data
(63) Continuation-in-part of application No. 16/158,833, filed on Oct. 12, 2018.
Application No. 16/158,833 is a continuation-in-part of application No. 16/707,519, filed on Dec. 9, 2019.
Application No. 16/707,519 is a continuation-in-part of application No. 16/158,833, filed on Oct. 12, 2018.

(30) Foreign Application Priority Data
Nov. 17, 2017 (TW) 106217150

(51) Int. Cl. G02C 7/04

(52) U.S. Cl. CPC G02C 7/047; G02C 7/044

(57) ABSTRACT

An orthokeratology lens is disclosed. A central optical zone is formed on an outer surface and an inner surface of the orthokeratology lens and can pass light to clearly focus on a central area of retina of eyeball; peripheral optical zones surround the central optical zone and can pass light to focus on a peripheral blurring area around the central area; a central part of the inner surface includes a base curve with eccentricity in range of 0 to 4, and a reverse curve, an alignment curve and a peripheral curve disposed outside the base curve in an outward order. A junction between the base curve and the reverse curve has a crossover point formed thereon, and a straight-line distance from the cornea of the eye ball to the crossover point between the base curve and the reverse curve is in range of 89 μm to 189 μm.

This application is a Continuation-In-Part of co-pending application Ser. No. 16/158,833, filed on Oct. 12, 2018, and application Ser. No. 16/707,519, filed on Dec. 9, 2019; and application Ser. No. 16/707,519, filed on Dec. 9, 2019 is a Continuation-In-Part of co-pending application Ser. No. 16/158,833, filed on Oct. 12, 2018; for which priority is claimed under 35 U.S.C. § 120, the entire contents of which are hereby incorporated by reference.

This application claims the priority benefit of Application No. 106217150 filed in Taiwan on Nov. 17, 2017.

### BACKGROUND OF THE INVENTION

### 1. Field of the Invention

The present invention relates to an orthokeratology lens. More particularly, the orthokeratology lens has a distance, which is from a crossover point formed between a base curve and a reverse curve to a cornea, in a range of 89 μm to 189 μm, so that the orthokeratology lens can provide more myopia peripheral defocus to improve myopia control effect, and the asymmetrical aspheric outer surface can effectively control myopia progression, thereby slowing or retarding myopia progression and correcting myopia in children/adolescents optically at the same time.

### 2. Description of the Related Art

Electronic Product Development connect people's daily lives to technology and enhance lifestyle/convenience. Especially the heavy use of computers, communications, and consumer (3C) electronic products results in the popularization of communication and internet technology applications. Many people immerse themselves in the use of 3C electronic products. Mobile phone overuse is seen among certain office workers, students, middle aged and elderly people. People everywhere are beginning to lose patience with the phenomenon known as phubbing: snubbing others in a social setting by checking your phone. Mobile phone overuse can also lead to vision impairment. The result of King's College London study from 2015, exploring the possible link between increased computer and smartphone use and rising rates of myopia.

Furthermore, the reason why people have myopia is mismatch between the eye's refraction and axial length, for example, when the eye axial length is too long or the corneal curvature is too steep, it causes the image focused at a point to fall in front of the retina, so the visual image blurs. Therefore, in order to correct myopia, it is necessary to reduce the eye's refraction; about 80% of the refraction occurs in the cornea, so reduction of refractive power of the cornea can correct myopia.

The existing methods to correct refractive error mainly include wearing glasses, wearing contact lens, corneal myopia surgery, or wearing orthokeratology lens. There are advantages and disadvantages of above different methods, and the orthokeratology lens will be especially described in following paragraphs. The orthokeratology lens is made of high oxygen rigid gas permeable material. When the orthokeratology lens is worn on an eyeball, a non-uniform layer of tear is sandwiched between the orthokeratology lens and an outer surface of cornea of the eyeball, and the tear can apply a positive pressure on the cornea to remodel epithelial cells; at the same time, when the wearer closes the eye wearing the orthokeratology lens, the cornea is applied a certain pressure by eyelid and the orthokeratology lens. Therefore, after the wearer wears the lens for a sufficient time, central curvature of the wearer's cornea can be gradually flattened and central epithelial layer of the wearer's cornea can be gradually thinned, so that the central portion of the cornea can be flattened and refractive power of the cornea can be reduced, thereby correcting the wearer's myopia.

However, the orthokeratology lens for controlling low myopia of between 0.50 and 4.00 diopters generally has poor effect on myopia progression. In order to understand why the problem occurred, the experimenters repeated experiments to obtain the experimental data shown in FIG. 5, which is a data diagram of tear thickness analysis in prior art. As shown in FIG. 5, tear thicknesses corresponding to the orthokeratology lenses with curvatures of 39, 42, and 46 for myopia of −5.00, −7.00, and −9.00 diopters are all above 90 μm. Compared with the orthokeratology lens for low myopia, the orthokeratology lens for correcting myopia of −5.00 diopters can provide more myopia defocus, thereby effectively controlling myopia. However, since the base curve of the conventional orthokeratology lens is spherical, the base curve and the reverse curve of the conventional orthokeratology lens for low myopia form insufficient space to accumulate tears, and it causes that the conventional orthokeratology lens for low myopia cannot effectively control myopia.

Therefore, how to solve the above-mentioned conventional problems and inconveniences is a key issue in the industry.

### SUMMARY OF THE INVENTION

In order to solve above-mentioned conventional problems, the inventor develops an orthokeratology lens with an aspheric structure in reverse curve according to collected data, multiple tests and modifications, and years of experience in the industry.

The primary objective of the present invention is that the orthokeratology lens includes a central optical zone formed on an outer surface and an inner surface thereof and configured to pass light to clearly focus on a central area of a retina of eyeball, and varies of asymmetrical peripheral optical zones surrounding the central optical zone and configured to pass light to focus on a peripheral blurring area around the central area. A central part of the inner surface includes a base curve, and the inner surface also includes, in an outward order, a reverse curve, an alignment curve and a peripheral curve disposed outside the base curve, and a junction between the base curve and the reverse curve has a crossover point formed thereon, and a straight-line distance from the crossover point to a cornea is in a range of 89 μm to 189 μm. The outer surfaces of the peripheral optical zones are aspheric. The straight-line distance from the crossover point to the cornea is in range of 89 μm to 189 μm, so the orthokeratology lens of the present invention can provide more myopia peripheral defocus than the conventional orthokeratology lens when a wearer's eyelid is closed, thereby achieving the purpose of providing more myopia peripheral defocus to improve myopia control effect.

The secondary objective of the present invention is that the outer peripheral surface consists of different regions and different amounts of asymmetrical aspheric, so that light passing the peripheral optical zones can create different amounts of peripheral blurring areas in front of different areas of a retina; this defocusing of the images, providing more controlled amount of myopic blur to the retina, which acts as a putative cue to slow myopic eye growth. Following animal studies that have demonstrated the strong inhibitory effect of peripheral myopic defocus on axial elongation or myopia develop, it has been hypothesized that inducing myopic retinal defocus may slow or retard the progression of myopia in children. Contact lenses provide the most viable opportunity to beneficially modify genetics and environment factors through their close alignment with the eye and consistent wearing time. The present invention will induce myopic retinal defocus by the asymmetrical aspheric surface of the lens to create different amounts of peripheral defocus onto varies regions of the retina, which acts as a putative cue, further, a ciliary muscle can be relaxed by putative cue, so that intraocular lens can become flatter and the light passing the peripheral optical zone can be imaged on the retina, thereby preventing the ciliary muscle of the eye ball from staying at the tight state for a long time and slowing myopic eye growth.

### BRIEF DESCRIPTION OF THE DRAWINGS

The structure, operating principle and effects of the present invention will be described in detail by way of various embodiments which are illustrated in the accompanying drawings.

FIG. 1 is a schematic view of optical paths of an embodiment of the present invention.

FIG. 2 is a schematic plan view of an orthokeratology lens of an embodiment of the present invention.

FIG. 3 is a sectional side view of an orthokeratology lens of an embodiment of the present invention.

FIG. 4 is a data diagram of distance between a cornea and an orthokeratology lens of the present invention.

FIG. 5 is a data diagram of tear thickness analysis in prior art.

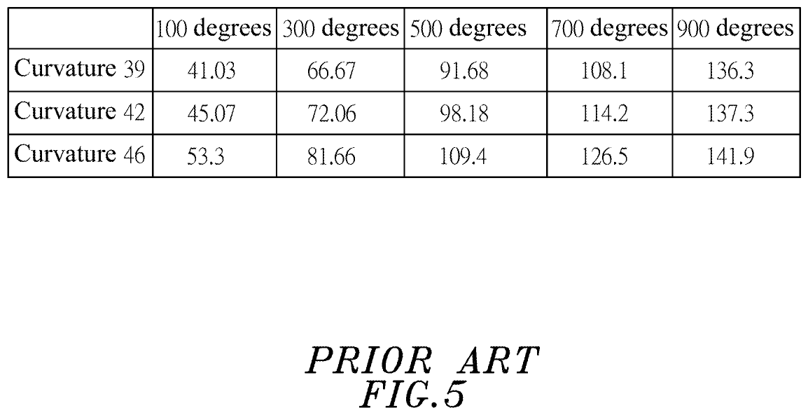

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

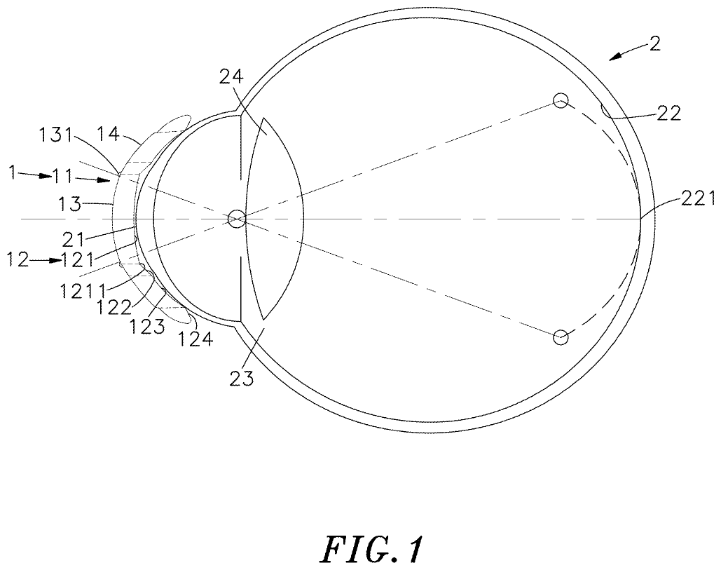

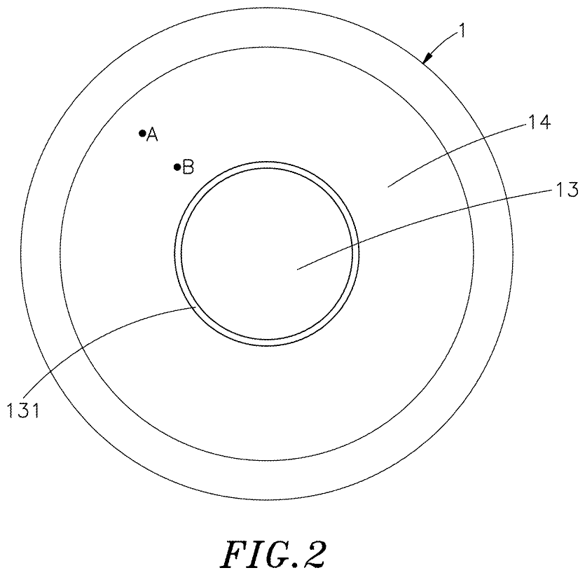

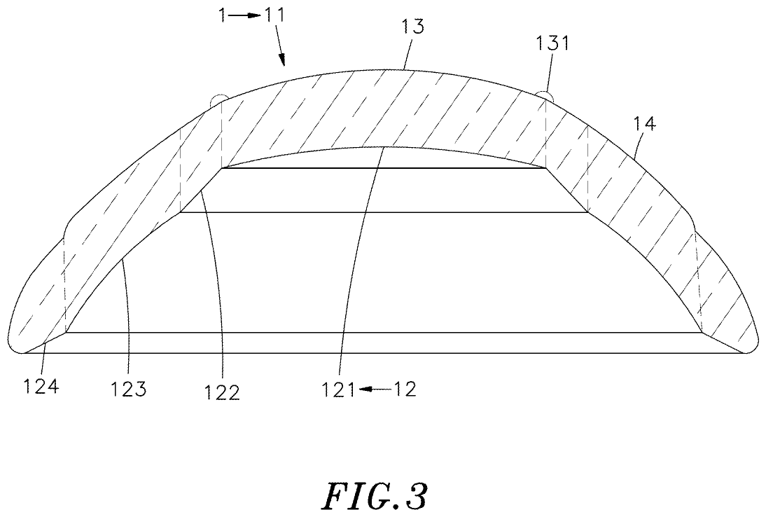

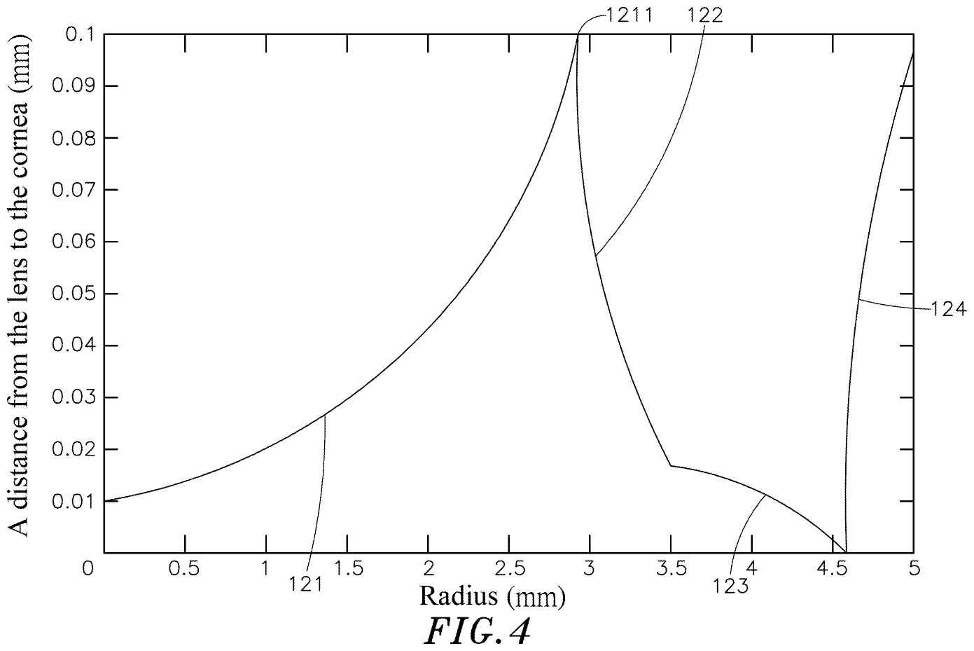

Please refer to FIGS. 1 to 4, which are a schematic view of optical paths, a schematic plan view of an orthokeratology lens, a sectional side view of an orthokeratology lens, and a data diagram of distance between a cornea and an orthokeratology lens, according to an embodiment of the present invention. As shown in FIGS. 1 to 4, the lens 1 can be worn on an eyeball 2. The lens 1 includes an outer surface 11 and an inner surface 12. The lens 1 includes a base curve (BC) 121 disposed on a central part of the inner surface 12 and having eccentricity in range of 0 to 4. The base curve (BC) 121 can be used to apply a positive pressure on the surface of the cornea 21 by tear (not shown in figures) sandwiched between the lens 1 and the cornea 21. The lens 1 further includes, in an outward order, a reverse curve 122, an alignment curve (AC) 123 and a peripheral curve (PC) 124 disposed outside the base curve 121, and a junction between the base curve 121 and the reverse curve 122 has a crossover point 1211 formed thereon, and a straight-line distance from the crossover point 1211 between the base curve 121 and the reverse curve 122 to the cornea 21 of the eyeball 2 is in range of 89 μm to 189 μm. The lens 1 includes a central optical zone 13 is formed on the outer surface 11 and the inner surface 12 and configured to pass light to focus on a central area 221 of a retina 22 of a wearer's eyeball 2. For example, the central area 221 can be the fovea of the retina 22.

In an embodiment, the outer surface 11 of the central optical zone 13 is aspheric, and the outer surface 1 of the peripheral optical zone 14 is aspheric.

The base curve 121 and the reverse curve 122 of the lens 1 are aspheric, that is, the eccentricity of each of the base curve 121 and the reverse curve 122 is non-zero.

Furthermore, a preset curvature of the base curve 121 is higher than a horizontal curvature of the cornea 21 of the eyeball 2, that is, the curvature of the base curve 121 is flatter than the horizontal curvature of the cornea 21; since the curvature of the base curve 121 is higher than the curvature of the cornea 21, when the lens 1 is worn on the eyeball 2, a positive pressure can be applied on epithelial cells of the cornea 21 by tear sandwiched between the base curve 121 and the cornea 21. Furthermore, the reverse curve 122 of the lens 1 can be used to store tears, so that a negative pressure applied by the tears can be used to improve effect of aligning the lens 1 on the eyeball 2.

In a preferable design, the peripheral curve 124 can have a slightly raised edge, so that the lens 1 can facilitate to squeeze out tears during blinking, to promote the tear circulation inside the lens 1, thereby continuously lubricating the contact area between the lens 1 and the cornea 21 of the eyeball 2 and delivering oxygen. Therefore, with the circulation of tears, the orthokeratology lens of the present invention can provide better wearability and comfort in wearing.

During production process of the lens 1 of the present invention, a processing machine can be used to make the eccentricity of the base curve 121 of the lens 1 in a range of 0 to 4, so that the base curve 121 with eccentricity in range of 0 to 4 can be used to make the straight-line distance from the crossover point 1211 to the cornea 21 of the eyeball 2 in a range of 89 μm to 189 μm. When wearing the lens of the present invention, a user can wear the lens 1 on the eyeball 2 to make the inner surface of the lens 1 contact the surface of the cornea 21 of the eyeball 2, and at this time, tears with non-uniform thickness can be sandwiched between the inner surface of the lens 1 and the cornea 21; when the user goes to bed at night and the user's eyelids (not shown in figures) are closed, the eyelid presses the outer surface of the lens 1, weights of the eyelid and the lens 1 can form a positive pressure, and the positive pressure can be applied to epithelial cells of the central part of the surface of the cornea 21 of the eyeball 2 via the tears sandwiched between the base curve 121 of the lens 1 and the cornea 21, so that the central curvature of the surface of the cornea 21 gradually becomes flatter subject to pressure applied by the tears, and the central epithelial layer of the cornea 21 becomes thinner to reduce refractive error of the cornea 21 and make the image focused at a point move toward the retina 22 of the eyeball 2, thereby achieving the effect of reducing degrees of myopia or eliminating degrees of myopia.

Since the straight-line distance from the crossover point 1211 between the base curve 121 and the reverse curve 122 to the cornea 21 of the eyeball 2 is in a range of 89 μm to 189 μm, the orthokeratology lens of the present invention can provide more myopia peripheral defocus than the conventional orthokeratology lens when the eyelid is closed, thereby achieving effect of improving myopia control.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An orthokeratology lens, comprising:
an outer surface;
an inner surface;
a central optical zone formed on the outer surface and the inner surface and configured to pass light to clearly focus on a central area of a retina of an eyeball; and
varies of asymmetrical peripheral optical zones surrounding the central optical zone and configured to pass light to focus on a peripheral blurring area around the central area, wherein the varies of asymmetrical peripheral optical zones include aspheric outer surfaces configured to pass to focus in front of the peripheral blurring area of the retina;
wherein a central part of the inner surface comprises a base curve with eccentricity in range of 0 to 4, and comprises, in an outward order, a reverse curve, an alignment curve and a peripheral curve disposed outside the base curve, and a junction between the base curve and the reverse curve has a crossover point formed thereon, and a straight-line distance from the cornea of the eyeball to the crossover point between the base curve and the reverse curve is in range of 89 μm to 189 μm, and eccentricity of the outer surface of the central optical zone is less than eccentricity of the outer surfaces of the peripheral optical zones.

2. The orthokeratology lens according to claim 1, wherein the orthokeratology lens is a lens of a contact lens.

3. The orthokeratology lens according to claim 1, wherein the inner surface of lens is aspherical.

4. The orthokeratology lens according to claim 1, wherein the outer surface of the central optical zone is aspheric.
